(19) United States
(12) Patent Application Publication
(10) Pub. No.: US 2005/0197969 A1
(43) Pub. Date: Sep. 8, 2005

(54) Organizational innovation enhancement technique

(76) Inventors: Mark W. McElroy, Windsor, VT (US); Steven A. Cavaleri, Rocky Hill, CT (US); Joseph M. Firestone, Alexandria, VA (US)

Correspondence Address: MCANDREWS HELD & MALLOY, LTD, 500 WEST MADISON STREET, SUITE 3400, CHICAGO, IL, 60661, US

(21) Appl. No.: 11/024,550

(22) Filed: Dec. 29, 2004

Related U.S. Application Data
(63) Continuation of application No. 09/672,483, filed on Sep. 28, 2000, now abandoned.

(51) Int. Cl. G06N 5/00

(52) U.S. Cl. 705/70

(57) ABSTRACT

A human social system has a tendency to self organize around one or more of the production, diffusion and application of organizational knowledge. One or more of the production, diffusion and application of such knowledge can be enhanced by synchronizing knowledge policies with the tendency. The synchronization may be accomplished by proposing knowledge embryology, politics, diversity and connectivity policies (step S10). The proposed knowledge politics policy is practiced in the social system and is evaluated and/or refined (step S20). The proposed knowledge embryology, diversity and connectivity policies are practiced in the social system with the evaluated proposed politics policy, and the policies are evaluated and/or refined as needed (step S30).

### CROSS-REFERENCE TO RELATED APPLICATIONS

This application is a continuation of application Ser. No. 09/672,483 filed Sep. 28, 2000, titled “Organizational Innovation Enhancement Technique,” which is incorporated herein by reference in its entirety.

### BACKGROUND OF THE INVENTION

1. Field Of The Invention

The present invention relates generally to the enhancement of innovation in and by human social systems, and relates more particularly to the management of policies which enhance a tendency of people in organizations to self organize around one or more of the production, diffusion and application of organizational knowledge.

2. Description Of The Prior Art

Introduction

Innovation in organizations has conventionally been seen as being the product of a series of unique insights, developed over time, by individuals with special expertise or knowledge. In this framework, the new knowledge developed by a relative minority of employees (i.e., such knowledge consisting of individually- or mutually-held knowledge of products, services, technologies, processes, markets, customers, strategies, operations, etc.) is then distributed to the majority of employees for adoption and application to improve performance. In this perspective, innovation is regarded as being primarily a centralized or non-distributed process. The kinds of research and development functions (R&D) or executive management teams typically found in most corporations exemplify this top-down administrative approach to innovation.

Innovation can alternatively be organized as a distributed function in which relatively large portions of an organization's employees participate in developing new knowledge, which is then shared with other employees. This is a mutually enriching process in which most employees are both consumers and producers of new knowledge. In other words, they may apply knowledge they have created, or use knowledge developed by others.

From an economic perspective this alternative model represents a shift from the use of a top-down administrative mechanisms to bottom-up market mechanisms for allocating the scarce resource of knowledge production functions. Given a choice, economists traditionally view markets as the most efficient and effective way to regulate the allocation of scarce resources. However, the traditional methodology used in organizations to regulate the production, diffusion, and application of new knowledge is through centrally-administered mechanisms. Here, certain people are designated to perform the specialized task of knowledge creation, whereas other people are administratively designated to perform the tasks of applying new knowledge in ways that are intended to improve organizational performance.

In organizations where distributed knowledge production is selected as the preferred strategy, a hybrid administrative and market system often functions to control the production and use of new knowledge. This hybrid approach has two common variations.

The first variation is to adopt policies that promote the creation of new knowledge across a relatively broad spectrum of an organization's employees, thus, transforming employees into entrepreneurs who are motivated by opportunities to produce new knowledge, and who function as collaborators in a community of fellow knowledge creators. In this first variation, there is no central administrative control or management; all knowledge production, diffusion and application (or use) is decentrally-controlled by self-organized groups operating in a distributed, market-oriented environment. This market functions to offer employees the discretionary choice of which new knowledge they will adopt in order to perform their work. Moreover, their individual decisions about what knowledge to embrace or reject are bolstered by the remarkable efficiencies of knowledge diffusion found in firms. Kogut and Zander (1992) argue that “what firms do better than markets is the sharing and transfer of knowledge of individuals and groups within an organization.” (p. 383)

The second variation of the hybrid approach is to design policies that enable an efficient market mechanism for new knowledge to operate within the organization, but to accompany those policies with strong centralized administrative support and management control. Clearly, organizations cannot operate as pure markets, even if there was a rationale to do so. Kogut and Zander (1992) continue, “a firm is distinct from a market because coordination, communication, and learning are situated not only physically in locality, but also mentally in an identity . . . . This shared identity does not only lower the costs of communication, but establishes explicit and tacit rules of coordination.” (pp. 502-503).

Notwithstanding the fact that the administrative mechanism can add value to market-oriented knowledge production processes, it alone is not sufficient to create optimal levels of new knowledge; there must also be a larger cultural identity that guides individual choices. Dyer and Noebeoka (2000) observe, “Thus, knowledge is most effectively generated, combined, and transferred by individuals who ‘identify’ with a larger collective. Creating an identity for a ‘collective’ means that all of the individual members feel a shared sense of purpose with the collective.” (p. 352).

In organizations where the top management team aspires to adopt a more market-driven knowledge production and sharing system, the traditional management structures used to implement administratively-driven knowledge production systems are inadequate; they must be replaced by market-friendly management systems that support the tendency of human social systems to self-organize around one or more of the production, diffusion and application of knowledge.

Indeed, many management theorists now hold the view that this tendency is endemic to all firms, and that left to their own devices, any population of workers in a human social system in which people operate interactively, and intensively, with one another towards achieving common goals will naturally exhibit certain knowledge- and innovation-related behaviors at the level of the whole system. Moreover, the patterns formed by these innovation-related social processes typically emerge independent of any top-down management effort being required to have them do so. In other words, human social systems, by their very nature, are bottom-up knowledge-making regimes. Innovation management methods that begin by recognizing such predispositional tendencies arguably stand a better chance of success than those which don't. The preferred embodiment of the present invention is predicated on the view that human social systems self-organize around the production, diffusion and application of knowledge, and is unequivocal in its recognition of such tendencies.

Knowledge Management and Innovation Prior Art

A review of prior art reveals that-there are no pre-existing processes or methods equal in form or content to the present invention. There are three known extant methods within the general category of knowledge management and innovation. These three methods are discussed below:

1. IBM Innovation Offering, a presentation given at Enterprise Intelligence Conference, Orlando, Fla., December, 1999 by Mark W. McElroy.

This method was designed with innovation improvement in mind; however, its primary focus was on the direct management of knowledge processes, as opposed to knowledge policies. Further, at the heart of the IBM method is a prescriptive model which was developed by Mr. McElroy and several other collaborators under the auspices of the Knowledge Management Consortium International (KMCI), a non-profit, public domain professional society of knowledge management practitioners.

The KMCI model describes a series of organizational dynamics by which human social systems (businesses, societies, communities, etc.) produce, diffuse and apply new knowledge. As such, it is a process model—a knowledge process model. Accordingly, the IBM method can also be characterized as a knowledge process redesign technique. It begins by recording the current complexion of knowledge processes in use by an organization, and then systematically takes steps to replace them with a set of preferred processes as specified by the prescriptive KMCI model. In practice, the IBM method is an application of business process re-engineering applied to knowledge and innovation-related business processes. As such, it falls into the general category of top-down administrative approaches to managing innovation.

2. The Toyota Production System, as discussed by Jeffrey Dyer and Kentaro Nobeoka, (2000), in their paper, “Creating and Managing a High-Performance Knowledge-Sharing Network: The Toyota Case”, Strategic Management Journal, # 21.

Previous research by these authors leads them to conclude that knowledge diffusion occurs more quickly within Toyota's production network that in competing automaker networks. Dyer and Nobeoka provide evidence that suppliers do learn more quickly after participating in Toyota's knowledge sharing network. The knowledge sharing network is a collective composed primarily of Toyota and its suppliers. Toyota has incorporated a numbers of rules to promote knowledge-sharing within the network. These rules prevent members from hiding valuable knowledge or free riding. The first rule is that Toyota has eliminated the notion that there can be any title to proprietary knowledge within the network. Toyota's rule states that very little of the knowledge that any member firm possesses is proprietary (with the exception of certain product designs/technology). Production processes are simply not viewed as proprietary.

Another of Toyota's rules calls for reciprocal knowledge sharing within the production network which entails the extension of free, mutual assistance amongst its suppliers as well as granting its suppliers full access to Toyota's operations and stock of knowledge. In addition to a rule that delimits property rights, the network has also established a rule that defines the timing and distribution of savings that result from knowledge transfers.

There is no corresponding process or methodology presented by the authors of this paper.

3. Edward Swanstrom (1999) Extreme Innovation Technique. The Extreme Innovation Technique was developed by Edward Swanstrom, former President and Director of the Knowledge Management Consortium.

The Extreme Innovation Technique (EIT) is an innovation improvement method which is designed to be used by an innovation manager, or team (EIT practitioners) as a method by which they attempt to improve a subject group's rate of innovation. In practice, EIT practitioners devise a number of potential innovation improvement schemes which they then deploy within the ranks of the subject group of workers. These workers might be an operating unit in a company, a department, or even an entire business.

Once the various innovation improvement ideas have been deployed, the EIT practitioners observe which of the competing ideas seem to be having the most favorable effect on the subject group's rate of innovation. Those ideas which appear to account for increasing rates of innovation are selected for reinforcement and broader deployment to other subject groups.

Moreover—and this is the hallmark of the EIT—ideas which seem to be having their most favorable effects on subject groups are “reverse inherited” by EIT practitioners, themselves. They then subject themselves to the same innovation improvement ideas that were proven successful in the field as they attempt to devise even more effective innovation improvement ideas for further use. Having done so, their own rates of innovation may increase, in which case new and potentially more effective methods for increasing the rate of innovation in subject groups are devised, deployed, and selected for broader deployment and, as in the first case, reverse inherited by EIT practitioners, themselves.

This cycle of idea development, trial deployment, selection, reinforcement, and reverse inheritance is repeated endlessly. This is the essence of the Extreme Innovation Technique, which unlike the knowledge-related policy transformation features of the present invention, focuses, instead, on open-ended trial-and-error and reverse inheritance by EIT practitioners as the substance of its approach.

It can be useful to think of knowledge and innovation management methods in terms of which of the three fundamental stages of organizational learning they are designed to address. The three fundamental stages, as defined by the life cycle reference model developed by the Knowledge Management Consortium International, are: 1) production, 2) diffusion, and 3) application, or use of additional value in reviewing knowledge and innovation management methods is not only to determine which of the three fundamental stages in the knowledge life cycle they address, but in what form(s) of intervention they do so. A useful framework for making this determination consists of the following:

Principles→Policies→Rules→Practices

This simple framework reflects the commonly-held view that principles (including values and beliefs) held by people and the organizations in which they work lead to the policies they adopt, which, in turn, lead to the rules they create, which, in turn, lead to the practices they make.

Methods that focus on principles would tend to make their interventions at the level of organizational culture. These might be thought of as cultural transformation methods aimed—in the present context—at knowledge production, diffusion and application, or use. Methods that focus on rules or practices can, instead, be thought of as process re-engineering techniques, which are geared more towards direct management of an organization's learning programs and behaviors. Policy-based approaches are less heavy-handed than rule- or practice-based schemes, and avoid altogether the difficulty that comes with attempts to shape nebulous principles or culture. Instead, they begin by recognizing that new policies might give rise to new corresponding desirable rules and practices, and that policies can be embraced as a reflection of an organization's principles, and as a way of promoting its principles without managing or dictating them, per se. Whether or not principles held by an organization's members actually change in the transaction is of less importance than is whether or not the rules and practices subsequently developed in accordance with new policies add up to the intended changes in behavior of interest (knowledge-related behavior, or innovation, in this case).

The combination of the two frameworks discussed above gives rise to the following evaluation matrix, or table, by which all knowledge and/or innovation management methods can be classified. Accordingly, the three methods discussed above have been so positioned:

| | Principles | Policies | Rules | Practices |
|---|---|---|---|---|
| Knowledge Production | EIT | EIT | EIT | EIT |
| | | | IBM | |
| Knowledge Diffusion | EIT | EIT | EIT | EIT |
| | | TPM | IBM | |
| Knowledge Application | EIT | EIT | EIT | EIT |
| | | TPM | IBM | |

Legend:
EIT = Extreme Innovation Technique
TPM = Toyota Production Method
IBM = IBM Innovation Acceleration Method

A review of the matrix above quickly reveals the fact that only the Extreme Innovation Technique falls into all categories. This is because its method advocates no prescriptive model, per se, and is only interested in open-ended trial-and-error wherever opportunities may lie to improve innovation. On the other hand, the approach it takes to do so, in which trial-and-error and “reverse inheritance” are employed, is distinctly different from the other methods, even in cases where they co-inhabit the same space in the matrix.

Indeed, this is the case with all the other methods shown above. While two or more such methods may be aimed at addressing the same dimensions of organizational learning, knowledge creation or innovation, they each take decidedly different approaches in doing so, using methods and processes that are substantially unique.

Related Theories and Concepts

There are a number of related theories and concepts that have been developed which are related to various aspects of the present invention. These concepts fall primarily into a number of general categories including: 1. Strategic Cognitive Mapping and Executive Belief Systems, 2. Corporate Governance, 3. Organizational Knowledge Creation, 4. Culture and Cultural Resonance, 5. Intrinsic Motivation and Learning, 6. Organizational Learning, 7. Policy Theory, and 8. Complexity Theory.

Strategic Cognitive Mapping and Executive Belief Systems

1. C. Eden and F. Ackermann (2000), “Mapping Distinctive Competencies: A Systematic Approach”: The relationship between patterns of competencies and the goals of an organization are explored as the basis for establishing core distinctive competencies and for developing and exploring the business model, which will inform strategic direction. The process involves developing causal maps that reveal shared executives beliefs. There is no corresponding process or methodology presented by the authors of this paper.
2. P. Cattopadhyay, W. Glick, C. Miller, and G. Huber (1999), “Determinants of Executive Beliefs and Comparing Functional Conditioning and Social Influence”: Executive beliefs influence strategic decisions in organizations, and thus, ultimately influence organization performance. The conventional wisdom is that executive beliefs usually originate in functional experience. However, the research by these authors indicates that beliefs held by upper-echelon executives are better explained by an alternate theoretical model based on social influence. The results indicate support for the argument that executive beliefs are socially reproduced through interaction among executives. There is no corresponding process or methodology presented by the authors of this paper.
   Corporate Governance
1. Frank Mueller (1995), “Organizational Governance and Employee Cooperation”: The field known as organizational economics' tries to resolve the problem of promoting cooperation in organizations through appropriate design of governance structure. The paper argues that this is largely a static approach that does not take into account dynamics caused by continuous feedback loops between behavior and design choice. Ever since the writings of the economist, Coase, in 1937, economists have acknowledged that administrative mechanisms are complementary to market systems. Unlike sociologists, who view power differentials between a ruling elite and less powerful groups as being the prime barrier to intrafirm cooperation, economists view the main obstacle to human cooperation in organizations as arising as a result of the overriding self-interests of individual agents, in both market-oriented and administrative systems. Economic models of cooperation ignore the continuous interaction between design choices made and the context into which choices are embedded. Mueller offers four propositions for creating a dynamic governance structure that promotes cooperation in organizations:

Proposition #1—Meanings and goals often develop dynamically, depending on the context. It is inadequate to construct actors as if they held context-free meanings and goals.

Proposition #2—The contribution of many organizational processes toward a cooperative outcome can only adequately be evaluated by looking at both historical and external context.

Proposition #3—Economic exchange is embedded into and interdependent with the dynamics of underlying social relations. Thus, constructs of trust are reenacted in daily routines and there can be no guarantee for stability through designing a governance structure.

Proposition #4—In addition to the above, problems of ambiguity and uncertainty pose further obstacles to finding a (governance) structural solution to the cooperation problem.

There is no corresponding process or method presented by the author of this paper.
2. William Ouchi (1982), “Theory Z”: Ouchi outlines a recipe for designing an effective governance structure:

The organization needs to maintain a holistic orientation.

It needs to force employees at all levels to deal with one another as complete human beings. In doing so, it must also ensure that the socialization of all to a common goal is complete, and that the capacity of the system to measure the subtleties of contributions over the long run is exact.

The Type Z organization succeeds only under social conditions that support lifetime employment.

The coordination in this system is provided by adherence to an underlying list of values that are deeply held and closely followed.

Trust consists of the understanding that “you” and “I” share fundamentally compatible goals in the long run, and thus we have reason to trust one another.

The result of such a governance structure is that autocracy is unlikely and that communication, trust, and commitment are common. There is no corresponding process or methodology presented by the author of this book.
3. Oliver Williamson (1999), “Strategy Research: Governance and Competence Perspectives”: The governance perspective gives greater prominence to economics, in that choice among alternative modes of governance is principally explained in terms of transaction costs and economizing, whereas the competence perspective gives greater prominence to organization theory—where the importance of process is especially featured. The governance perspective is best represented by Chester Barnard's view that adaptation was the central problem of economic organizations. Barnard emphasized cooperative adaptation of a ‘conscious, deliberate, purposeful’ kind, working through administration (Barnard, 1938, p. 4).

Key elements of Barnard's theory of internal organization included (1) a theory of authority, (2) the employment relation, (3) informal organization, and (4) economizing. The competency approach is defined in terms of an organization's capacity to create routines and skills that have a causally ambiguous distinctive competence that drives performance in ways that are not easily duplicated by outsiders.

There is no corresponding process or methodology presented by the author of this paper.
4. W. Warner Burke and George H. Litwin (1992), “A Causal Model of Organizational Change and Performance”: The authors propose a model that links organizational functioning and organizational change. Change is depicted in terms of both process and content, with particular emphasis on transformational as opposed to transactional factors. This model depicts management practices as directly affecting systems (policies and procedures) which directly influence organizational culture. All of these are viewed as ultimately affecting both individual and organizational performance.

There is no corresponding process or methodology presented by the authors of this paper.

Organizational Knowledge Creation

1. Georg von Krogh (1998) “Care in Knowledge Creation”: The author argues that managers should take extraordinary care in knowledge creation—based on constructionist theories of knowledge production (e.g. Maturana and Varela). “Effective knowledge creation puts particular demands on the way people relate to each other in a company.” Untrustworthy behavior, constant competition, imbalances in giving and receiving information, and a “that's not my job” attitude endanger effective sharing of tacit knowledge. Constructive and helpful relations among people speed up the communication process, enable organizations to share their personal knowledge and to discuss their ideas freely.

Overall, good relations purge a knowledge-creation process of fear, mistrust, and dissatisfaction. Once good relations have been established, the organization's members will then have the confidence and freedom to satisfy their needs and aspirations to explore unknown territories, such as new markets, new customers, new products, and new manufacturing technologies.“(p. 136).

There is no corresponding process or method presented by the author of this paper.
2. Georg von Krogh, Johan Roos, and Ken Slocum (1994), “An Essay on Corporate Epistemology”: This essay attempts to recast the process of strategic management as a knowledge intensive process, and redefine knowledge as a self-organizing process. Self-organizing processes are explained by using Maturana and Varela's concept of autopoiesis (Maturana and Varela, 1980). According to these two authors, there are two conditions that need to be satisfied for knowledge to connect in an organization over time: (1) the availability of relationships, and (2) a self description. First, the organization consists of a set of relationships that enable immediate knowledge connections. Organizational members develop informal relationships over time that can ensure that the distinctions they convey are further built on and developed by others. Organizational members are also related to one another through organizational structures and reporting relationships. These facilitate communication among individuals and may therefore allow for organizational knowledge to develop. Second, knowledge connections require an adequate self-description of the organization (Luhmann, 1990). A self-description results from an ‘observation’ by the organization of itself. In fact, a ‘self-description formulates the identity of the organization’ (Luhmann, 1990). This provides criteria for selecting what passes for knowledge, and that, as such, should be further connected, as opposed to ‘noise’ that should not be connected.” (pp.61-62).

There is no corresponding process or method presented by the authors of this paper.
3. J-C Spender (1996), “Making Knowledge the Basis of a Dynamic Theory of the Firm”: Much of the organizational culture literature is grounded in a distinction between formal and informal aspects of organizational life. Nelson and Winter (1982) suggest that habitual use of a routine embeds it in the ‘taken-for-granted’ cultural knowledge of the firm. Thus, the knowledge become traditional, making the charismatic individual that creates the routine logically prior to the process of institutionalization that produces the organization. But there is a stronger converse argument. Individuals cannot be proficient until they are “socialized” into an organization, until they have acquired much of the collective knowledge that underpins ‘the way things are done around here.’ Reber (1993) has taken this even further, seeing that tacit knowledge of the social collective is phylogenetically prior to the concept of the individual and, therefore, the possibility of individual explicit knowledge. Thus, Reber grounds the progression from preconscious mechanistic solidarity to conscious organic solidarity, which Durkheim observes in evolutionary biology. In less biological terms, collective knowledge becomes the basis of human meaning and communication—what the receiver must know to comprehend the semantic content of the message.

There is no corresponding process or method presented by the author of this paper.

Culture and Cultural Resonance

1. Timothy Kubal (1998), “The Presentation of Political Self: Cultural Resonance and Collective Action Frames”: This author develops a theory that explains the effectiveness of political movements in terms of resonance between leaders, followers, and “movement frames.” “Frame resonance occurs when there is cognitive alignment between a movement's ideology and the beliefs of an adherent or constituent.” “Cultural resonance accents the alignment between movement frames and symbols in the cultural environment. Cultural resonance increases the appeal of a frame by making it appear natural and familiar.” The idea of cultural resonance has been used to understand the construction and influence of movement frames.

There is no corresponding process or method presented by the author of this paper.
2. Richard Seel (2000), “Culture and Complexity: New Insights on Organizational Change”: The focus of organizational change interventions moves away from planning change and onto facilitating emergence. The model proposed is based on the epidemiological approach of the French anthropologist Dan Sperber.

There is no corresponding process or method presented by the author of this paper.
3. Stephen Grossberg Ph.D. (1987) “Theory of Adaptive Resonance in Neural Networks”: Grossberg's theoretical approach in psychology, artificial intelligence, and neuroscience views our brain as consisting of neural networks. These neural networks are represented by various cognitive subsystems. Grossberg has proposed that when something significant is learned, some neural network or cognitive subsystem resonates. The primary activity of each neural network is trying to match current knowledge (in the form of expectations) with inputs. When there is too much mismatch, the network searches for other expectations to match the input. This search process produces arousal. Inadequate expectations or hypotheses are like a net with big holes—too much input escapes the expectations caused by under capacity of abilities to process the input. The input that cannot be processed produces increased search resulting in arousal, confusion, or anxiety. If the expectations match this input too well, then little is learned and the result is low search for new hypotheses, low arousal, and boredom.

Harmonious functioning is like using a net with a few holes. An optimal degree of matching between input and expectations causes resonance. Resonance causes optimal stimulation and arousal. It may be the major cause of what learning psychologists call reinforcement, at least at a cognitive level. An optimal degree of matching between inputs and predictions is the state that causes optimal learning and optimal stimulation. It is like fitting a key piece of a puzzle together.

There is no corresponding process or method presented by the author of this paper.
4. Gary Pisano (1994), “Knowledge, Integration, and the Locus of Learning: An Empirical Analysis of Process Development”: A framework is presented which links approaches to experimentation and the structure of underlying knowledge. Although the concept of learning-by-doing is well accepted in the literature, the framework here suggests that where underlying scientific knowledge is sufficiently strong, effective learning may take place outside the final use environment in laboratories. The results suggest there is no one best way to learn, but that different approaches may be required in different knowledge environments.

There is no corresponding process or method presented by the author of this paper.

Intrinsic Motivation and Learning

The applicants also are aware of articles dealing with intrinsic motivation or learning:
1. Maslow (1965), “Self-Actualization and Beyond,” Proceedings of the Conference On The Training Of Counselors Of Adults.
2. Condry and Koslowski (1977), “Can Education Be Made ‘Intrinsically Interesting’ To Children?”.
3. Deci and Ryan (1981), “Curiosity and Self-directed Learning: The Role of Motivation in Education.”
4. Kamada (1987), “Intrinsic and Extrinsic Motivation Learning Processes: Why Japanese Can't Speak English.”
5. Zbrzezny (1989), “Effects of Extrinsic Rewards on Intrinsic Motivation: Improving Learning in the Elementary Classroom.”
6. Nichols and Miller (1993), “Cooperative Learning and Student Motivation.”

1. The Maslow Talk and Interview is a discussion of intrinsic learning versus extrinsic learning. Intrinsic is learning driven from within by needs that must be satisfied; doing so successfully leads to self-actualization and is marked by periodic peak experiences. The role of the therapist is to help people become aware of these inner needs and to encourage their fulfillment.

Maslow's focus is exclusively on the individual learner and he in no way addresses the notion of organizational learning. Neither does he address the social processes that accompany organizational learning, much less the notion of adopting synchronized polices at an organizational level designed to support and reinforce them. It could be said that what Maslow is advocating is the adoption of learning policies at an individual level which are shaped by an understanding of how individuals learn and what they want to learn. The “what” in this case is determined by his (Maslow's) hierarchy of needs. But Maslow, himself, does not characterize his perspective in these terms, nor does he prescribe a methodology that could be said to be comparable with the present invention, not even when applied to the level of individual learning.

Last, Maslow's focus on intrinsic is not only confined to learning by individuals, but is chiefly concerned with what individuals want to learn, not how. Maslow is concerned with individual learning needs and related strategies for therapy interventions.

2. J. Condry and B. Koslowski Article—These authors focus on the difference between intrinsic motivation and extrinsic motivation, in terms that are roughly equivalent to intrinsic learning and extrinsic learning. Intrinsic learning follows from intrinsic motivation; extrinsic learning follows from extrinsic motivation. They argue convincingly that extrinsic motivation, usually in the form of incentives, rewards, and punishments, actually diminish learning when compared to the quality and effectiveness of learning that follows from intrinsic motivation.

The authors then move on to discuss patterns of intrinsic learning and the significance of these patterns as applied to teaching methods. They conclude that teaching approaches should be taken in accordance with how children naturally learn as opposed to how teachers wish to teach.

Here again, the authors, like Maslow, are concerned only with individual learning and are not at all focused on the notion of organizational learning. They do advocate the same general approach to managing learning environments (i.e., that natural learning patterns, or behaviors, should determine the learning environment, not the reverse). Unlike Maslow's talk, they also focus on the learning process, not just the target or products of learning. One could say that while Condry and Koslowski focus on the role and importance of intrinsic motivation and learning, Maslow offers an explanation of what's driving the motivation of interest (i.e., his so-called hierarchy of needs).

This work also suffers from the assumption that learning requires the assistance or participation of a teacher, whose methods need only be revised in order to take the principles of intrinsic learning and motivation into account. As such, its process implications point to teaching methods as opposed to policy-based organizational learning as envisioned by the preferred embodiment of the present invention.

Further, both Maslow and Condry et al, 1) deal only with individual learning, not organizational learning, and 2) while they focus on learning processes, or behaviors, as determinants of teaching methods, they do not prescribe a comprehensive method, per se, that teachers should, or could, use in response. Accordingly, there is no process or method specified by the authors in their work.

3. E. Deci and R. Ryan Article—These authors echo many of the same point made by Condry and Koslowski. In addition, they focus on the issue of how extrinsic motivations conspire against teachers, themselves, in their efforts to leverage their students' intrinsic motivations. Here again, the focus is on individual learning, not organizational learning. In addition, there is no methodology proposed, per se, that would make it possible for a reader or a practitioner to act on their intrinsic learning insights.

4. L. Kamada Article—This article cites much of the same theory as discussed in the articles above, however, Kamada goes much further in the direction of prescribing practices. Nonetheless, this article also focuses exclusively on teaching individuals and does not offer a comprehensive methodology for transforming teaching practices to the self-organized learning habits of whole social systems.

5. R. Zbrzezny Study—A study of the literature related to intrinsic learning and related teaching models. Exhibits much of the same content and limitations as described above for the other papers.

6. J. Nichols and R. Miller—This paper reports the results of so-called cooperative group instruction techniques and its effects on individual learning. As such, its focus on individual learning is consistent with the others above. There is no concept of organizational learning, per se, discussed, nor is there any methodology prescribed for moving from traditional teaching environments to the group method. In any case, the target of the work described was enhanced teaching methods for individual learning, not for organizational innovation, as is the case with the preferred embodiment of the present invention. Further, the authors' analysis of why group learning fetched such markedly better results than traditional passive-style teaching was admittedly incomplete, citing the need for more research.

The preceding six articles single-mindedly focused on teaching methods for learning by individuals, not by organizations, and they offer no processes or methods by which educators—their target audience—might transform their practices in order to exploit their students' intrinsic motivations. The characteristics of such methods are described only in tentative or anecdotal terms, and it is left to the reader's imagination as to exactly how one should go about creating a teaching environment that leverages intrinsic learning, and what its complete description might be.

The issue raised above concerning the difference between individual learning and organizational learning is an important one. It is perhaps best explained by pointing to the underlying difference between individual knowledge and organizational knowledge. While individual knowledge is held individually by individuals, organizational knowledge is knowledge which is mutually-held, and/or collectively practiced, by multiple individuals in a human social system.

By the same token, individuals acquire individually-held knowledge by engaging in individual learning. Organizations, however, acquire organizationally-held knowledge by engaging in certain self-organized patterns of social behavior. Organizational learning, therefore, comprises a social process enacted at the level of whole organizations that is distinctly different from episodes of individual learning.

Organizational Learning

As the new field of knowledge and innovation management (KIM) has grown in popularity, there has been a renewed interest in organizational learning (OL). The resurgence of interest in OL as an approach for promoting innovation is not coincidental. Most simply, KIM is the single best implementation strategy for OL. Many people now realize that the main product of OL is knowledge, and knowledge is the capacity for effective action.

The concept of organizational learning has it origins in the pragmatist philosophy of Peirce, James, and Dewey, and an anthropological view of organizations. When we say an anthropological view, we mean that organizational knowledge is understood as being embedded in a network of social relations, and organizational culture. This all sounds rather like an intellectual discourse, but in reality OL is quite simple.

OL starts with the notion of action learning. OL has less to do with classroom experiences or education than it does with the idea that the sole purpose of knowledge is to help humans act with reliable effectiveness. Knowledge is created when experience is used as the ‘ground’ that enables us to test out our idea about how things really work. The simplest version of this process can be found in the action learning cycle that is most often attributed to John Dewey.

Action learning is a dualistic process. We do something to the world and the world does something back to us. Another way to frame this relationship is as yin/yang or extroverting/introverting. More often than not, managers who are under pressure to perform mistakenly find greater leverage in emphasizing the doing part rather than the sense-making part. The action parts of the cycle are doing and experimenting. The sense-making parts are reflecting and hypothesizing. According to this perspective, the essence of learning through experience (work) is to take intentional action; mentally capture what was done, what happened, and in what context; then develop a possible explanation for why things turned out the way they did; formulate this explanation as a new hypothesis about how things really work; and then experiment by trying new types of actions that are expected to be effective in yielding desired goals if the system really functions as you understand it.

The key point to be made here is that action learning is not about learning new data or information from any sources outside of one's experience. Rather, it is essentially about a person's ability to draw meaning from their experience in such a way that it enables them to first, change their mind about how things really work, make new knowledge claims about how cause and effect actually function in any given situation, and act differently in accord with new understandings.

While this may seem like a completely individual process, action learning is just the first step in knowledge creation. The second feature that is essential for OL is the tension that develops between people who perform the same work and yet offer different explanations for what actually happened, why it happened, or what results will occur if different actions are taken in the future.

This is where the various self-organizing communities come into play. As members of the community socialize and seek possible explanations for their learning experiences a variety of conflicting, and often competing knowledge claims are proposed. Over time and through social interaction people become aware of the incoherence, incompleteness, and habitual patterns present in their own reasoning process and those of others. As one of the OL's thought leaders Chris Argyris has noted, people are prone to engage in ‘defensive reasoning’ to protect their views from open scrutiny.

Simply realizing the limits of ones beliefs is not easy for most people. The reason for this is that people tend to identify with their causal beliefs rather than viewing them as tools to be replaced if they do not perform well. As Argyris (1990) notes, “Defensive reasoning occurs when individuals (1) hold premises the validity of which is questionable yet they think it is not, (2) make inferences that do not necessarily follow from the premises, yet they think they do, (3) reach conclusions that they believe they have tested carefully, yet they have not because the way they have been framed makes them untestable.” (p. 10)

What happens next is often a matter of speculation. In some organizations, community forums become battlefields of competing ideas in which all that is often left are many ‘walking wounded’ who come away feeling scarred, scared, or angry. In other organizations, a consensus explanation may develop among committed inquirers and the new view becomes accepted as being valid or true.

Often times, these new understandings find their way to becoming embedded in an organization in the form of the three Rs: rituals, routines, and rules. Over time, as new habits are formed and these once radical or novel explanations become taken for granted by successive generations of employees, they become socially embedded. That is, they are not even discussed, just assumed.

In the ideal, such OL processes offer organizations a two fold benefit. First, new ideas and practices become shared among people who really want to use them, as opposed to some best practices sharing system that forces employees to use new ideas. Second, the quality of knowledge claims is improved over time through a variety of processes including dialogue and collaboration.

Now we can clearly see that OL is a sterling method for forming and refining knowledge claims. It is primarily a framework for drawing new meaning from individual experiences in a way that influences various communities, and enables the communities to shape individual knowledge though social interaction and reciprocity.

Organizational Learning in Practice

The past decade was marked by a profound shift in the way both practitioners and researchers have discussed organizational learning. We view the just completed decade (1990-1999) as representing the second generation of OL research and praxis. The writings of second-generation writers, such as Peter Senge (1990, 1994, 1999), and colleagues with affiliation to MIT, such as, DiBella, Edmondson, Isaacs, Kim, Kleiner, Nevis, Roth, and Sterman represent several major advances in OL thought. We will refer to this approach as the MIT school of thought.

Other leading theorists around the world, such as Dixon, Handy, Revans, and March have also made significant contributions to this newer generation of OL theory. Largely, their work has built on the shoulders of first-generation OL giants, such as Argyris and Schon. Upon the publication of Argyris' and Schon's book, Organizational Learning in 1978, a predominant view arose which was based on the concepts of “double-loop learning,” differences between espoused theories of action and theories-in-use, and feedback. Essentially, this approach built on a number of advances in the social sciences, systems theories, and epistemology.

Argyris' and Schon's work synthesized important intellectual threads ranging from basic systems principles drawn from C. West Churchman, Herbert Simon and cyberneticist Norbert Weiner, well as the theories of inquiry, science, and knowledge found in the works of philosophers John Dewey, Michael John Stuart Mill, Michael Polyani, and Karl Popper.

Finally, a central feature of the writing was the notion of “variables” and “patterns of causality” as found in the writings of both Simon, and Campbell and Stanley (1963). The essential feature of this primary first-generation OL research was its focus on the belief that managers could improve the quality of their decision making by using the feedback of unanticipated results to trigger a process that would surface their deeply held beliefs about causality and question their validity. The hoped-for response was that, in the face of under-performance, managers would be able to break the reinforcing cycle produced by their habitual patterns of thought, and develop new alternative strategies that were better suited to producing the desired results in business.

Clearly, this approach focused on the role of individual managers interpreting their experiences in the context of an organizational setting, but did not explicitly address the group or cultural dimensions of organizations. Argyris' (1977) definition of OL makes this distinction quite clear: “Organizations learn through individuals acting as agents for them. The individual's learning activities, in turn, are facilitated or inhibited by an ecological system of factors that may be called an organizational learning system.”

In such systems, when agents (usually managers) are able to become aware of the fallibility of their own theories-in-use, they will be less prone to defend and advocate the use of ineffective theories to others. Thus, the effect is to dampen the propagation—or diffusion—of nonviable models of practice and to break the cycle that tends to reinforce the continued use of practices that are unlikely to yield desired results.

The major contribution of this pioneering first-generation work in OL was differentiating the cyclical process of ‘learning from work experience’ from the diatribe and catechism that people normally associate with learning. More importantly, such learning in the organizational milieu was viewed as being directly related to performance. Unlike other forms of learning, OL was defined as a way of learning to discover what works best. Here, the founders of OL cast learning in the same light as the American pragmatist philosophy developed by such legendary visionaries as Charles Peirce, widely regarded as the greatest American philosophy, William James, the father of American psychology, and John Dewey. The first generation of OL founders placed their greatest emphasis on describing the human process of learning from experience through the operation of various feedback mechanisms interacting with each individual's set of beliefs.

Second-generation OL writers have shifted the emphasis of OL in several important ways. First, the leaner cybernetic perspective has been replaced by the more robust descendant of system dynamics known as “systems thinking” in many, more recent approaches, such as those proposed by the MIT school of OL theorists. As is clearly detailed in Senge's ‘five disciplines’ (1990) of becoming a learning organization, the learning of individual agents becomes integrated with team learning and the organization-wide collective sense of purpose that he terms as “shared vision.” According to Senge, “Organizations intent on building shared visions continually encourage members to develop their personal visions. If people don't have their own vision, all they can do is “sign up” for someone else's. The result is compliance, never commitment. On the other hand, people with a strong sense of personal direction can join together to create a powerful synergy toward what I/we truly desire.” (p. 211).

Through the inclusion of ‘team learning’ and ‘shared vision,’ Senge has in some respects developed a framework of OL practice that addresses some of the limitations of first generation approaches. Unfortunately, these additional elements have their own limitations as well. To be sure, Senge and his colleagues have provided detailed ethnographic accounts of team learning, and the value it may potentially bring. They have furthered the development of many OL tools, such as Isaacs' work on dialogue, Roth and Kleiner's work on learning histories, and Jaworski and O'Brien's work on generative leadership. They have also popularized the use of specific tools of eliciting mental models, such as dialogue, ladder of inference, and left hand-right hand column exercises, but they define relatively few prescriptions for collaborative team learning that are related to business processes.

Despite Senge's and others' advances in OL theory in recent years, there are relatively few descriptive models of the processes and social mechanisms of team learning. There are even fewer prescriptive models of effective processes for promoting organizational learning. Certainly, Nonanka and Takeuchi (1995) have perhaps come the closest in tackling this issue with some fervor as they outline a set of processes for knowledge-creation. Allee (1997) has also introduced a number of models that help managers to establish processes that leverage organizational learning to spur the creation of new knowledge.

Nevertheless, all of the well-intended efforts toward developing OL suffer from the same underlying problems. Approaches that examine OL as being separate or distinct from knowledge are inherently ungrounded. They fail to develop effective processes because learning is viewed as an entity unto itself. And while most OL practitioners tip their hat to knowledge and innovation management (KIM), they rarely go far enough to admit that knowledge is the sole raison d'être for organizational learning.

This is an unfortunate slide down the slippery slope leading away from the foundations of OL in pragmatist philosophy. In pragmatist philosophy, especially the Peircian version, learning, knowledge and action can never be separated from each other.

Unlike the pragmatism of James and Dewey that is focused on the value of clear thinking to produce effective action, Peirce perhaps goes one step further with his rationale. The purpose of thought is not ultimately, effective action. Rather, according to Peirce, “Thought in action has for its only possible motive the attainment of thought at rest;” That is, effective action tells us about the correctness of our beliefs. Thought comes to rest when beliefs are chosen that reliably produce effective action.

How Does OL Lead to Knowledge?

There surely are many varying definitions of knowledge with each offering different possibilities for new insights on the sources of organizational innovation. Western philosophers generally define knowledge as “justified true belief.” Prusak and Davenport regard knowledge as being “a fluid mix of framed experience, values, contextual information, and expert insight that provides a framework for evaluating and incorporating new experiences and information.” (p. 5)

Such definitions are useful, but they do not distinguish between individual and collectively-held or shared forms of knowledge.

Policy Theory

Organizational behavior, or practice, can be seen as the expression of organizational knowledge, or rules, which are determined by policy. Policy, in turn, is guided by principles, values and beliefs. According to this view, principles give rise to policies, which beget rules, which, in turn, influence behavior, or practices, in the organizational milieu:
Principles→Policies→Rules→Practices
   In management, while the control of organizational practice is usually the goal, doing so at the level of individual behavior or transactions is impractical. The working experiences of employees are simply too complex and too unpredictable to account for in the form of prescribed rules that can be applied in such a way as to thoroughly anticipate every event. Principles, on the other hand, are too far removed from practice and cannot be legislated anyway. Policies, then, are the manager's best tools when it comes to guiding behavior.

As managers responsible for policy-making in an entirely different arena—wildlife management, a discipline not too far afield from human management—have observed, “Policies create or bestow values [Principles] as well as determine how they will be distributed [i.e., diffused into practice by way of rules]. . . ” (G. Meffe, C. R. Carroll, and Contributors; Principles of Conservation Biology, Sinauer Associates, Inc., 1997, Sunderland, Mass.).

The word policy has so many varied meanings that a number of books devote entire sections to define the term. Moreover, the use of the term depends, in part, on the field in which it is used. For example, in political science, the term public policy often refers to legislation, whereas business policy generally connotes operating guidelines. Here, we will confine our discussion of the meaning of the term policy to its use in business organizations. In particular, we will place our emphasis on the use of the term in the strategic management literature and in the field of system dynamics.

Within the discipline of strategic management, policy is viewed as the last stage of a four-step process. The prior steps, in order of sequence are, 1) defining the firm's purpose and mission, 2) designing strategies to fulfill the purpose and mission, 3) setting goals and objectives to serve as measurable performance targets, and 4) creating policies to implement the agreed upon strategies. In this context, the word policy is often used synonymously with the terms ‘guidelines’ and ‘rules’.

Thompson and Strickland (1978) view policies as being of greater specificity than guidelines, but serving a less detailed role than rules. Pearce and Robinson (1985) define policy as “specific guides to managerial action and decisions in the implementation of strategy.” These authors also identify eight major purposes of policies including:
1. Policies establish indirect control over independent action by making a clear statement about how things are now to be done.
2. Policies promote uniform handling of activities.
3. Policies ensure quicker decisions by standardizing answers to previously answered questions that would otherwise recur and be pushed up the management hierarchy again and again.
4. Policies help institutionalize basic aspects of organization behavior.
5. Policies reduce uncertainty in repetitive and day-to-day decision making thereby providing a necessary foundation for coordinated, efficient efforts.
6. Policies can counteract resistance to or rejection of chosen strategies by organization members.
7. Policies offer a predetermined answer to routine problems, giving managers more time to cope with non-routine matters.
8. Policies afford managers a mechanism for avoiding hasty and ill-conceived decisions in changing operations.

The term, policy, has a different meaning in the field of system dynamics. The field of system dynamics began at MIT in the mid-1960s as a computer based method for understanding the effects of feedback structures on the relationship between business decisions and performance. System dynamics, as founded by Professor Jay Forrester, views policies as sets of decision rules that are employed to execute a cohesive strategy.

More specifically, Forrester defines policy as follows, “Policy is a formal statement describing the relationship between information sources and resulting information flows.” (p. 96) In a similar vein, James Lyneis, another MIT professor, describes policy by contrasting it with a decision: “A policy is a general rule that states how decisions are made on the basis of available information: a policy might state how a company's dividend payments depend on earnings, earnings growth rate, return on equity, and cash availability. In contrast, a decision is the policy application to a specific set of information:” According to Lyneis, every policy has four components: 1) desired conditions or goals, 2) apparent conditions, 3) speed of response, and 4) corrective action.

In general, policy-making is used in the practice of conventional management as a means of prescribing or influencing organizational behavior, including behaviors related to innovation. By contrast, the preferred embodiment of the present invention reverses this practice, and comprises a method by which policies are determined by behavior—self-organized behavior, in particular. Certain knowledge- and innovation-related organizational behaviors are seen as endogenous to, and self-organized in, human social systems with such behaviors, therefore, being independent of, and antecedent to, external influence. In cases where such endogenous behaviors are desirable, the preferred embodiment of the present invention offers a means by which policies designed to be synchronized with and to complement such behaviors can be implemented. The desired behavioral tendencies are thereby strengthened and reinforced to the advantage of organizations, whose knowledge- and innovation-related behaviors flourish in response, accordingly.

Complexity Theory

Complexity theory, or complexity science, can be defined as the study of emergent order in complex, disorderly systems. While many complexity scientists focus on such emergent order in physical or inanimate systems (i.e., such as in chemistry or meteorology), other complexity scientists focus, instead, on the principle of emergence in ‘living systems.’ The corresponding body of thought (i.e., complexity theory as applied to living systems) is referred to as ‘complex adaptive systems theory,’ or CAS theory, for short (pronounced, KASS theory).

Of particular interest to CAS theorists is the emergence of order from disorder in the form of ‘knowledge.’ CAS theorists recognize the emergence of knowledge at three levels in human social systems: 1) knowledge held by individuals, 2) knowledge mutually-held by many individuals in unified groups or communities, and 3) knowledge mutually-held by many individuals in entire organizations (groups of individuals and groups).

Most important to CAS theorists is the notion that all knowledge held by individuals, groups or entire organizations is the product of self-organized efforts to produce, diffuse and apply knowledge. A cyclical pattern of self organization is very carefully described in the work of Ralph Stacey (1996) in which he says:

“The science of complexity studies the fundamental properties of nonlinear-feedback networks and particularly of complex adaptive networks. Complex adaptive systems consist of a number of components, or agents, that interact with each other according to sets of rules that require them to examine and respond to each other's behavior in order to improve their behavior and thus the behavior of the system they comprise. In other words, such systems operate in a manner that constitutes learning. Because those learning systems operate in environments that consist mainly of other learning systems [other individuals and groups, or communities], it follows that together they form a coevolving suprasystem that, in a sense, creates and learns its way into the future.” (Stacey, 1996).

Stacey's work, and others', make it clear that the primary function of complex adaptive systems is to make it possible for their inhabitants to survive by learning; and that learning in such systems is performed by self-organized ‘learning structures’ composed of individuals and communities, who persistently interact with one another in certain characteristic ways (i.e., in accordance with their learning-related ‘tendencies’) through which individuals and groups, or communities, perform the production, diffusion and application of organizational knowledge. These structures and dynamics are most evident in human social systems, which are regarded by complexity scientists as a special class of CAS (i.e., social CASes).

Stacey and others are also quick to observe that the social structures which evolve in this way do so in a manner that also gives rise to intellectual diversity and dense connectivity amongst and between their members within such systems. To this point, Stacey says, “In human systems, the rate of information flow, the level of diversity in schemas [knowledge sets], and the richness of connectivity among agents all remain as control parameters, but further control parameters are added.” (p. 114).

Another well-known complexity theorist, John Holland, also sees diversity and connectivity as essential properties of complex adaptive systems. In his own book on CAS theory entitled, Hidden Order (Holland, 1995), he explains that, “the coherence and persistence of each system [that is, the survival and viability of each CAS] depend on extensive interaction [information flow and connectivity], the aggregation of diverse elements [intellectual diversity, in the case of human social systems], and adaptation or learning.” (p. 4).

Holland's description of CAS theory also offers an attractive explanation for the phenomenon of self-organized communities of interest. He refers to the social mechanism by which such communities form as “tagging”—a means by which individuals co-attract one another into the formation of like-minded or attribute-sharing groups:

“Tags are a pervasive feature of CAS because they facilitate selective interaction. They allow agents [individuals] to select among agents or objects that would otherwise be indistinguishable. Well-established tag-based interactions provide a sound basis for filtering, specialization, and cooperation. This, in turn, leads to the emergence of meta-agents [groups] and organizations that persist even though their components are continually changing. Ultimately, tags are the mechanism behind hierarchical organization—the agent/meta-agent/meta-meta-agent/organization so common in CAS.” (pp. 14-15). Stacey's work describes how people in organizations naturally coalesce into knowledge-making and knowledge-validating communities, while Holland's description of tagging provides a more granular description of the co-attraction dynamics involved. Stacey models how knowledge-making power and authority is distributed across, and animated by, individuals and groups operating within CAS frameworks.

CAS theorists, such as Stacey and Holland, assert the presence and importance of diversity and rich internal communications schemes in the health and well-being of CASes.

While the literature on CAS theory is unequivocal in asserting the self-organized manner in which human social systems produce, diffuse and apply new knowledge, there are no corresponding processes or methods to be found in the field which advocate management interventions at the level of knowledge-related policies as a means of achieving synchronization between such policies and the self-organized tendencies, and as a means of improving organizational learning and innovation. The preferred embodiment of the present invention fills that gap.

### PRIOR ART REFERENCE

1. Argyris, C. (1990). Overcoming Organizational Defenses, Boston, Mass., Allyn and Bacon.

2. Argyris, C. and Schon, D. (1996). Organizational Learning II, Reading, Mass., Addison-Wesley.

3. Barnard, C. (1938). The Functions of the Executive, Cambridge, Mass., Harvard University Press.

4. Burke, W. and Litwin, G. (1992). “A Causal Model of Organizational Performance and Change,”Journal of Management, Vol. 18, pp. 523-545.

5. Campbell, D. and Stanley J. (1963). Experimental and Quasi-Experimental Design For Research, Skokie, Ill., Rand McNally.

6. Chattopadhyay P., Glick, W., Miller, C. and Huber, G. (1999). “Determinants of Executive Beliefs: Comparing Functional Conditioning and Social Influence,” Strategic Management Journal, Vol. 20, pp. 763-789.

7. Condry, J. and Koslowski, B. (1977), “Can Education Be Made ‘Intrinsically Interesting’ To Children?”, ERIC Report PS 00984 ED153706.

8. Davenport, T. and Prusak, L. (1998). Working Knowledge, Boston, Mass., Harvard Business School Press.

9. Deci, E. and Ryan, R. (1981), “Curiosity and Self-directed Learning: The Role of Motivation in Education,” ERIC Report PS 012319 ED 206377.

10. Dyer, J. and Noebeoka, K. (2000). “Creating and Managing a High-Performance Knowledge-Sharing Network: The Toyota Case,” Strategic Management Journal, Vol. 21, pp. 345-367.

11. Eden, C. and Ackerman, F. (2000). “Mapping Distinctive Competencies: A Systemic Approach,” Journal of the Operational Research Society, Vol. 51, pp. 12-20.

12. Extreme Innovation Technique [see Swanstrom listing below].

13. Forrester, J. (1965). Industrial Dynamics, Portland, Oreg., Productivity Press.

14. Grossberg, Stephen, Ph.D. (1987) “Theory of Adaptive Resonance in Neural Networks,” Cognitive Science, Vol. 11, pp. 213-245.

15. Holland, J. (1995). Hidden Order, Reading, Mass., Perseus Books.

16. Kamada, L. (1987), “Intrinsic and Extrinsic Motivation Learning Processes: Why Japanese Can't Speak English,” ERIC Report FL 016888 ED285408.

17. Kogut, B. and Zander, U. (1992). “Knowledge of the Firm, Combinative Abilities, and the Replication of Technology,” Organization Science, Vol. 3, pp. 383-397.

18. Kogut, B. and Zander, U. (1996). “What do Firms Do? Coordination, Identity, and Learning,” Organization Science, Vol 7. pp. 502-517.

19. Kubal, T. (1999). “The Presentation of Political Self: Cultural Resonance and The Construction of Collective Action Frames,” The Sociological Quarterly, Vol. 39, pp. 539-554.

20. Luhmann, N. (1990). Essays on Self-Reference, New York, Columbia University Press.

21. Lyneis, J. (1980). Corporate Planning and Policy Design, Cambridge, Mass., Pugh-Roberts Associates.

22. Maslow (1965). “Self-Actualization and Beyond,” Proceedings of the Conference On The Training Of Counselors Of Adults, pp. 108-131.

23. Maturana, H. and Varela, F. (1980). Autopoiesis and Cognition, Dordrecht, Holland, D. Reidel.

24. McElroy, M. (1999). “Increasing The Rate of Corporate Innovation—Knowledge Management's Killer App,” A Presentation Given At The Enterprise Intelligence Conference in Orlando, Fla. in December, 1999.

25. Meffe, G., Carroll, C. and Contributors (1997). Principles of Conservation Biology, 2^{nd} Edition, Sunderland, Mass., Sinauer Associates, Inc.

26. Mueller, F. (1995). “Organizational Governance and Employee Cooperation: Can We Learn from Economists,” Human Relations, Vol. 48, pp. 1217-1235.

27. Nelson, R. and Winter, S. (1982). An Evolutionary Theory of Economic Change, Cambridge, Mass., Belknap Press.

28. Nichols, J. and Miller, R. (1993), “Cooperative Learning and Student Motivation,” ERIC Report ED 359254 TM 020023.

29. Nonanka, I. and Takeuchi, H. (1997). The Knowledge-Creating Company, New York, N.Y., Oxford University Press.

30. Ouchi, W. (1982). Theory Z, New York, Avon Books.

31. Pearce, J. and Robinson, R. (1991). Strategic Management, Homewood, Ill., Richard D. Irwin.

32. Pisano, G. (1994). “Knowledge, Integration, and The Locus of Learning,” Strategic Management Journal, Vol. 15, pp. 85-100.

33. Reber, A. S. (1993). Implicit Learning and Tacit Knowledge: An Essay on the Cognitive Unconscious,” New York, Oxford University Press.

34. Seel, R. (2000). “Culture and Complexity: New Insights on Organizational Change,” Internet website, “www.new-paradigm.co.uk/culture-complex.htm”

35. Senge, P. (1990). The Fifth Discipline, New York, N.Y., Doubleday/Currency.

36. Senge, P., Roberts, C., Ross, R., Roth, G. and Smith, B. (1999). The Dance of Change, New York, N.Y., Doubleday/Currency.

37. Senge, P., Ross, R., Smith, B., Roberts, C., and Kleiner, A. (1994). The Fifth Discipline Fieldbook, New York, N.Y., Doubleday/Currency.

38. Spender, J.-C. (1996). “Making Knowledge the Basis of a Dynamic Theory of the Firm,” Strategic Management Journal, Vol. 17 (Special Winter Issue), pp. 45-62.

39. Stacey, R. (1996). Complexity and Creativity in Organizations, San Francisco, Calif., Berrett-Koehler Publishers.

40. Swanstrom, E. [Anonymously] (1999). “The Extreme Innovation Technique,” [Published Variously on The Internet and Circulated in the Public Domain].

41. Thompson, A. and Strickland, A. J. (1978). Strategy and Policy—Concepts and Cases, Plano, Tex., Business Publications, Inc.

42. Von Krogh, Roos, J, and Slocum (1994). “An Essay on Corporate Epistemology,” Strategic Management Journal, Vol. 15, pp. 53-71.

43. Von Krogh (1998). “Care in Knowledge Creation,” California Management Review, Vol. 40, pp. 133-153.

44. Williamson, O. (1999). “Strategy Research: Governance and Competence Perspectives,” Strategic Management Journal, Vol 20, 1087-1108.

45. Zbrzezny, R. (1989), “Effects of Extrinsic Rewards on Intrinsic Motivation: Improving Learning in the Elementary Classroom,” ERIC Report PS 018214 ED309870.

The applicants are aware of U.S. Pat. Nos. 4,744,027; 4,895,518; 5,016,170; 5,313,560; 5,684,964; 6,029,043; 6,029,158; 6,032,141; 6,058,413 and 6,064,971. While some of these patents deal with decision support methods, none of them suggests synchronizing knowledge policies with any tendency of people in organizations to self organize around one or more of the production, diffusion and application of organizational knowledge.

### SUMMARY OF THE INVENTION

The invention is useful in a human social system having a tendency to self organize around one or more of the production, diffusion and application of organizational knowledge. According to one embodiment of the invention, one or more of the production, diffusion and application of such knowledge is enhanced by synchronizing organizational knowledge policies with the tendency.

The invention also is useful for providing instruction concerning a human social system having a tendency to self organize around one or more of the production, diffusion and application of organizational knowledge.

According to another embodiment of the invention, one or more of the production, diffusion and application of such knowledge is enhanced by offering advice about synchronizing knowledge policies with the tendency.

The invention also is useful in a human social system having a tendency to self organize around one or more of the production, diffusion and application of organizational knowledge in cases where its use may include a data store and a communication network. In such an environment, the enhancement of one or more of the production, diffusion and application of such knowledge and the synchronizing of knowledge policies with the tendency is supported by storing data relating to one or more of the organizational knowledge and the knowledge policies in the data store and communicating over the network to facilitate the synchronizing.

By using one or more of the foregoing techniques, human social systems, including businesses, can transform their current approach to one or more of knowledge production, diffusion and application to a market-oriented state in which both the rate and quality of organizational innovation are improved.

### BRIEF DESCRIPTION OF THE DRAWINGS

FIG. 1 is flow diagram illustrating a preferred form of the invention.

FIG. 2 is a flow diagram illustrating in more detail a preferred form of the step of proposing knowledge embryology, politics, diversity and connectivity policies shown in FIG. 1.

FIG. 3 is a flow diagram illustrating in more detail a preferred form of the step of practicing, evaluating and/or refining the proposed knowledge politics policy in the social system shown in FIG. 1.

FIG. 4 is a flow diagram illustrating in more detail the step of practicing, evaluating and/or refining the proposed knowledge embryology, diversity and connectivity policies with the evaluated proposed politics policy in the social system as shown in FIG. 1.

FIG. 5 is a flow diagram illustrating in more detail the steps shown in FIG. 1 and incorporates the steps shown in FIGS. 2-4.

FIG. 6 is a schematic block diagram of a preferred form of apparatus, including a data store and a communication network, useful in connection with one embodiment of the invention.

### DETAILED DESCRIPTION OF THE PREFERRED EMBODIMENTS

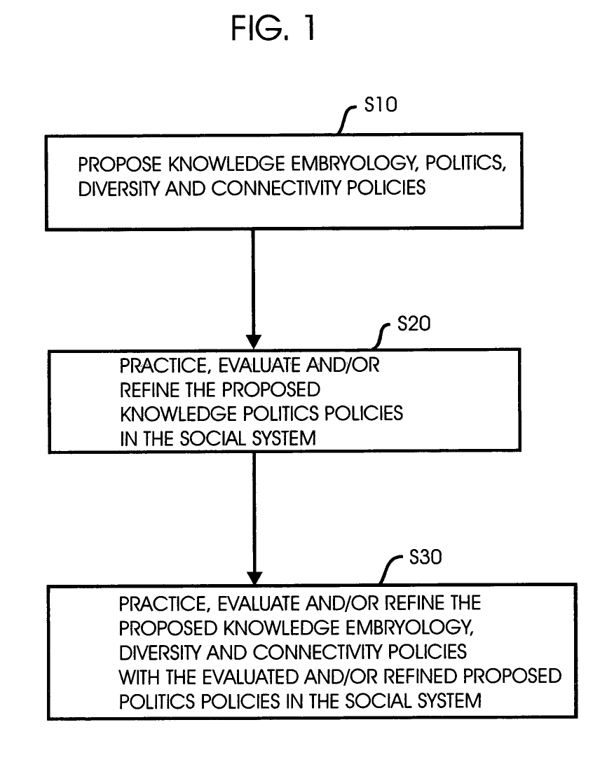

Referring to FIG. 1, the preferred embodiment of the present invention comprises a method for improving a human social system's organizational learning capabilities, its rate and quality of innovation, and its capacity to produce, diffuse and apply new or existing knowledge, by introducing policies designed to support, strengthen or reinforce related behaviors, such that the related behaviors progress from some current state to a future state in which the behaviors are more fully realized and more collectively practiced.

Although others have recognized that knowledge is the most important result of organizational learning, as far as the applicants are aware, they are the first to recognize that knowledge, action, and social self-organization are the starting points for effective organizational learning.

Unfortunately, organizational learning (OL) is often mistakenly seen as being closely associated with training of individuals, information storage (e.g., transfers of information between a teacher and student), and mastery of a specific predefined set of information content. However, the applicants have discovered that organizational learning is a rather unique natural process that can be enabled by various managerial and technological tools. Essentially all collective forms of learning begin with people who bring their knowledge, and experience gained through action, to social relations. The output of OL is not just knowledge, but rather socially embedded rules, declarations of insight, and causal claims. In particular, knowledge policies are synchronized with the tendency of a human social system to self organize around the production, diffusion and application of organizational knowledge. Here, the phrase ‘organizational knowledge’ is defined as knowledge which is mutually-held, and/or collectively practiced, by multiple individuals in a human social system.

Knowledge policies are best understood if knowledge is explained. In the context of the preferred embodiment, knowledge is a store of potentially effective acts that may be held by both individuals and groups. Acts are decision rules created and applied through the use of various forms of reasoning, such as deduction. The value of any act to an organization is determined by the consensus of a community of committed practitioners/inquirers. This special community is composed of not simply practitioners, but by those practitioners who are able to hold sufficient doubt about the effectiveness of acts in fulfilling their designated purpose to cause them to engage in inquiry.

One way to understand the degrees of reliability of certain acts or sets of acts to reliably produce desired results is to view knowledge as a developmental process. Just as all plants and animals live through various phases of development from birth to maturation and finally death, knowledge follows a similar pattern. Much like human lives, organizational knowledge leaves its own legacy that helps in developing new and improved forms of knowledge as it remains embedded in the organization's culture, routines, and policies.

The resulting pattern of knowledge production and innovation revealed by this legacy is generally as follows: 1) Individuals form knowledge claims, 2) Individuals join community of interest populated by other like-minded individuals; communities of interest self-organize, accordingly, 3) Individuals propose knowledge claims to groups or communities, 4) Communities test knowledge claims, 5) Communities validate knowledge claims, 6) Validated knowledge claims propagate into practice leading to continued use, modification, and eventual obsolescence, 7) Legacy knowledge claims become embedded in the social fabric and culture of an organization (organizational memory), 8) Old knowledge claims give way to new ones as individuals and communities continually form and validate better knowledge claims. As one can see, knowledge is something that evolves over time based on self-organized efforts to continuously improve its quality.

FIG. 1 illustrates the progression of general steps required for the preferred method. The preferred embodiment of the present invention may be implemented in the form of a methodology that consultants, knowledge managers, innovation specialists, or other practitioners concerned with organizational learning and knowledge production, diffusion and application will use as the basis of making their interventions in the field. It is also expected that practitioners who use the present invention will employ supporting tools and techniques that fall outside the scope of the present invention, but which will be useful and necessary to perform their work.

1. Introduction

The preferred embodiment makes use of the idea that human social systems have a tendency to self-organize around one or more of the production, diffusion and application of organizational knowledge.

The applicants' study of the self-organization tendency has revealed a cyclical pattern to its occurrence. First is the tendency of individuals to engage in self-directed learning; next is the tendency of like-minded individuals to co-attract one another into the formation of affinity groups, or communities of interest; next is the tendency of affinity groups, or communities, to produce and validate community-based knowledge which is escalated to the level of the organization's authority structure (management) for further review, validation and adoption. Knowledge that is adopted by management groups is then propagated, or diffused, across the organization, during which process it becomes embedded and expressed in practice by the many (application of knowledge).

The preferred embodiment makes it possible for users to improve either their own or other organizations' rate and quality of organizational innovation by providing them with a means of determining how policies practiced in four specific areas of interest determine an organization's level of innovation performance, as well as a means by which innovation performance improvements through the adoption of new policies in the same four areas can be achieved.

As used in this specification, a policy is a formal statement of a general rule that enables either affirmative, preventive or corrective actions to be taken based on the availability of some specified type of information. Policies provide standard solutions to routine problems or decision-making situations that offer greater control over performance and organization behavior. As expressions of general rules, polices provide high-level guidance and direction, on the basis of underlying principles, for the development of more specific rules which can be applied in practice by members of an organization. Based on the preceding meaning of policy, the four areas of policy relevant to the preferred embodiment are:

Embryology of Knowledge: The embryology of knowledge can be traced to the extent to which individuals in an organization are free to pursue their own learning agendas, and the degree to which they are further free to self-organize into knowledge making communities of interest or practice. The Embryology dimension breaks down into two sub-components: Individual Learning and Community Formation. Applying the methodology would therefore entail the study of an organization's current policies and practices in these two areas, as well as the potential implementation of new ones. In this regard, the preferred embodiment is far more comprehensive in breadth than the intrinsic motivation or learning literature discussed in the Background section of this application, since it deals explicitly with the subject of organizational learning and innovation, as well as the role played by communities of interest, or practice, in collective knowledge-making.

Synchronizing Embryology of Knowledge policies with the tendency of human social systems to self-organize around individual learning and community of interest, or practice, formation can have the effect of causing these behaviors to become more fully realized and collectively practiced. As a result, the rate and/or quality of organizational innovation can be improved.

Politics of Knowledge: The politics of knowledge-making, diffusion and application, or use, in an organization can have a dramatic impact on overall rates of business innovation and the quality of ideas produced. Most organizations tend be organized oligarchically around these functions. The “Politics of Knowledge” refers to the distribution and dynamics of power in human social systems according to which organizational knowledge and the rules by which it will be diffused and applied in practice are produced. Knowledge-related political systems are similar in shape and form to political systems of governance, with the most common form consisting of oligarchies. In business, for example, most significant organizational knowledge, such as strategies and organizational designs, are created by boards of directors or senior-level management teams. The vast majority of workers in such systems play a minor role, if any, when it comes to creating the knowledge that they are, nonetheless, expected to practice. These top-down knowledge-creating oligarchies are distinctly different, by contrast, to consensus-oriented, or democratic knowledge-making systems, in which everyone in the organization has an opportunity to participate in the creation of organizational knowledge as well as the rules by which it will be diffused and applied throughout the organization—i.e., bottom-up systems.

Synchronizing Politics of Knowledge policies with the tendency of human social systems to self-organize around the production, diffusion and application of organizational knowledge—including rights, or entitlement, to such knowledge—can have the effect of causing these behaviors to become more fully realized and collaboratively practiced. As a result, the rate and/or quality of organizational innovation can be improved.

Intellectual Diversity of Knowledge: The degree to which an organization supports a plurality of ideas, even dissident ones, will, too, have a material impact on its overall performance in innovation. Firms which seek diversified intellectual ethnographies tend to be more innovative than those which don't.

Synchronizing Intellectual Diversity of Knowledge policies with the tendency of human social systems to self-organize around the establishment, maintenance and support of intellectual diversity in an organization can have the effect of causing the organization's rate and/or quality of innovation to improve.

Connectivity of Knowledge: The density of communications and networks in organizations—social ones and otherwise—are also important to business innovation. The degree to which a culture values effective communications and connectivity between individuals and groups will, therefore, also influence the rate and quality of its innovation performance.

Synchronizing Connectivity of Knowledge policies with the tendency of human social systems to self-organize around the establishment, maintenance and support of effective communications between individuals and groups in an organization can have the effect of causing the organization's rate and/or quality of innovation to improve.

The combination of policies in all four of these categories is referred to in the preferred embodiment as an organization's knowledge operating system, or KOS. By systematically seeking to identify and evaluate the impact of an organization's current policies in these four areas, the rate and/or quality of organizational innovation can be improved over time. According to this method, policies deemed counter-productive to, or unsynchronized with, the tendency of human social systems to self-organize around organizational learning and innovation are amended, eliminated or replaced. The preferred embodiment provides just such a systematic method by which the policies are synchronized with a social system's tendency to self organize around the production, diffusion and application of organizational knowledge.

2. The Method

The preferred embodiment is useful in the context of a human social system, such as an organization, including a business. In such a context, the preferred embodiment may be implemented by following three steps in general. Each of the three steps can be broken down into a series of additional steps which results in a 13-step process.

Referring to FIG. 1, in step S10, knowledge embryology, politics, diversity and connectivity policies are proposed. In step S20, the proposed knowledge politics policies in the social system are practiced, evaluated and/or refined. In step S30, the proposed knowledge embryology, diversity and connectivity policies are practiced, evaluated and/or refined with the evaluated proposed politics policies in the social system.

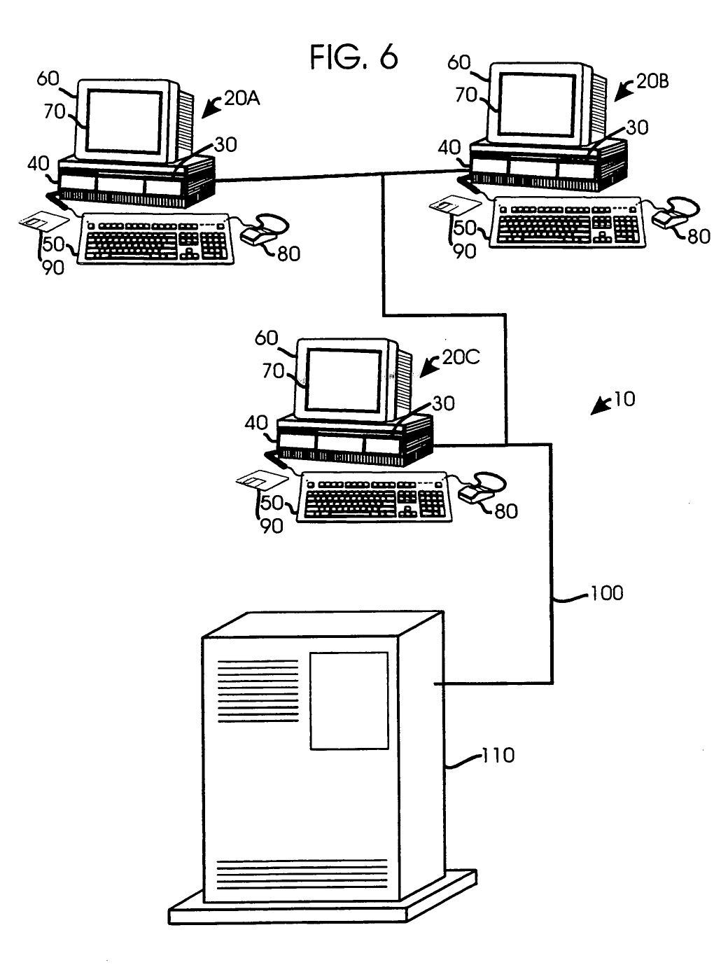

Referring to FIG. 6, a computer system 10 may be used to facilitate the practice of the preferred embodiment. System 10 includes three identical data processors each comprising a personal computer 20A, 20B and 20C. Each personal computer comprises a memory or data store 30, a central processing unit 40, a keyboard 50 for inputting data, a monitor 60 having a display 70 and a mouse 80. A floppy disk memory 90 may be used to input and store data in connection with the personal computers.

The system also includes a server computer 110 which serves as a gateway facilitating communication among the personal computers over a network 100 that may be a local area network, a wide area network, or the Internet. For example, the personal computers may communicate via email stored in server 100. Each of the personal computers may include a modem (not shown) to aid communication over network 100.

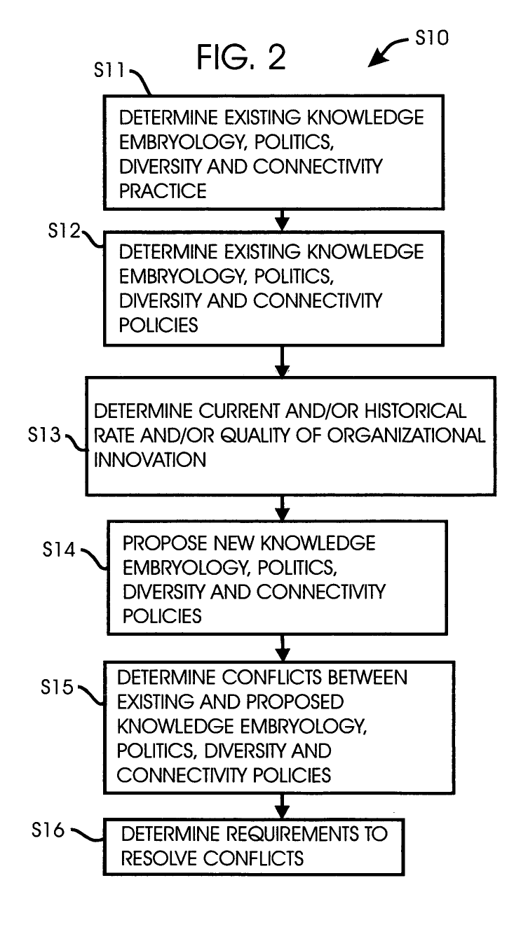

Referring to FIG. 2, step S10 may be further divided into steps S11-S16 as shown.

In step S11, the existing knowledge embryology, politics, diversity and connectivity practice of the social system are determined. This step may include the discovery and documentation of rules and procedures related to the current knowledge operating system (KOS) extant in the four policy areas of interest for purposes of baselining the existing complexion of practice in the knowledge production, diffusion and application. A broad range of third-party tools and techniques may be used to do so. The computer system 10 also may be used in this step for processing relevant data from data stores 30 and for communicating the data and the results of the processing over network 100. Results are expressed as an organization's current knowledge-related practices, but not policies, and may be displayed on displays 70.

In step S12, the existing knowledge embryology, politics, diversity and connectivity policies of the human social system are determined. This step may include the discovery and documentation of policies held in the four areas of interest. In step S12, the practices identified in step S11 above are traced to their underlying policies, thereby revealing the principles and policies held by an organization in the same four areas of interest. Results are expressed as policies held in the four areas of interest, which, collectively, is referred to as an organization's knowledge operating system, or KOS. Computer system 10 may be used in this step for processing relevant data contained in data stores 30. The data and results of the processing may be communicated over network 100.

In step S13, the rate and/or quality of organizational innovation is determined. Determining whether or not improvements in the rate or quality of innovation have occurred as a downstream consequence of interventions made at later stages in the preferred embodiment of the present invention requires that an organization's preexisting status in both areas be established at the outset. Accordingly, this step may baseline the current and historical rate and quality of organizational innovation. A broad range of third-party tools and techniques may be used to complete this task. In addition, computer system 10 may be used in this step for processing relevant data contained in data stores 30. The data and the results of the processing also may be communicated over network 100.

In step S14, initial knowledge embryology, politics, diversity and connectivity policies are proposed. In other words, desired policies for each of the four areas of interest are defined. In this step, practitioners develop the new or amended policies proposed for implementation throughout the organization in each of the four areas of the KOS. Policies to be eliminated are identified here as well. Results of this step are expressed as a prescriptive model. The proposed policies are synchronized with the tendency to self organize around the production, diffusion and application of organizational knowledge. Computer system 10 may be used in this step for processing relevant data contained in data stores 30. The data and the results of the processing may be communicated over network 100.

In step S15, conflicts between exiting and proposed knowledge embryology, politics, diversity and connectivity policies are determined. In other words, conflicts between the current KOS and the prescriptive model are determined. Once an organization's existing KOS has been discovered and documented (steps S11 and S12), comparisons may be made between current and desirable conditions (i.e., between the results of steps S12 and S14). Computer system 10 may be used during this step to process relevant data contained in data stores 30 regarding the existing KOS. The data and results of the processing may be communicated over network 100.

In step S16, the requirements to resolve the conflicts determined in step S15, if any, are identified. For example, step S15 may assess the impact and level of effort required to resolve conflicts. Each of the conflicts identified in step S15 above will potentially require interventions to resolve any gaps found. This is a planning step which forecasts the level of effort required to complete the overall process and the projected impact on the organization involved (usually expressed in terms of people, process, technology and financial resource requirements).

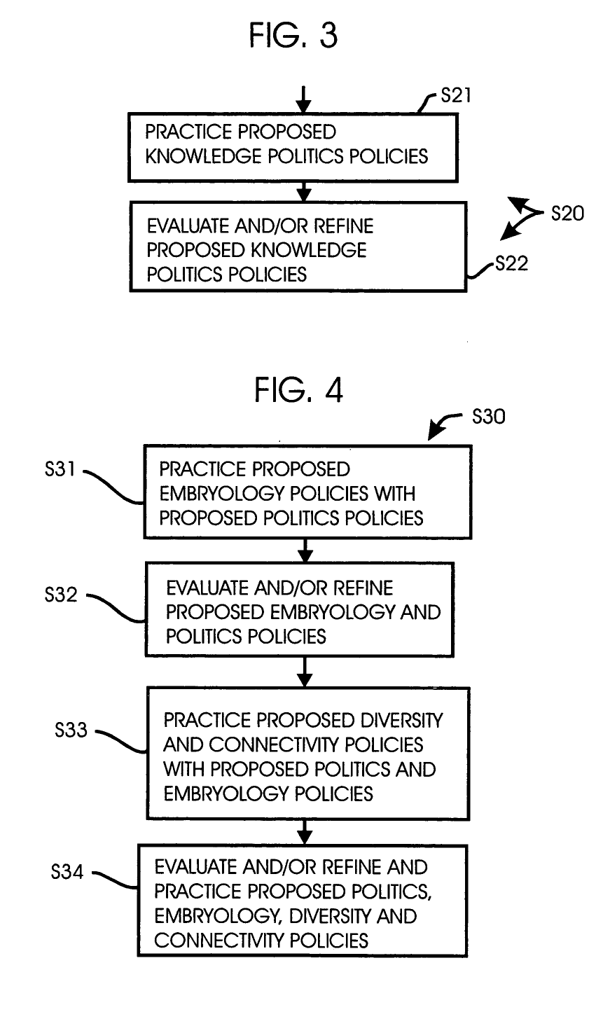

Referring to FIG. 3, step S21 includes the practice of the proposed knowledge politics policies. In other words, step S21 comprises initializing a prototypical political system using the proposed model. Accordingly, this step involves implementation of a provisional knowledge-making political system that will take responsibility for all knowledge-related policy transformations from this point forward (i.e., KOS-related only). The provisional scheme is based on the prescriptive model defined in step S14, but ultimately redefines itself into a form that more fairly reflects actual organizational preferences. The initial form is, therefore, for bootstrapping purposes only. Computer system 10 may be used to help implement step S21 by processing data regarding the practice contained in data stores 30. The data and the results of the processing may be communicated over network 100 to computers 20A-20C.

In step S22, the proposed knowledge politics policies and the prototypical system initialized in step S21 are evaluated and/or refined. In other words, step S22, customizes the bootstrapped political system by recursively subjecting itself to its own knowledge production processes. This is the step at which the initialized political system customizes itself and takes on a preferred structure and operating system of its own choosing. Included in its transformation are not only the knowledge production processes of interest, but also the preferred manner in which knowledge will be diffused and applied throughout the organization. Also addressed are policies related intellectual property entitlement. Conclusions reached at step S14 are revisited here, as well. Computer system 10 may be used in this step for processing relevant data regarding this step and step S21. The data and the results of the processing may be communicated over network 100.

Referring to FIG. 4, in step S31, the proposed embryology policies are practiced with the evaluated and/or refined proposed politics policies. In other words, step S31 subjects the prescribed embryology policies to the customized political system. This step S31 therefore includes some deliberate knowledge making in the area of individual learning and community formation. The conclusions reached at steps S21 and S22 are revisited here, as well. Computer system 10 may be used in this step S31 for processing data regarding the practice contained in data stores 30. The data and the results of the processing may be communicated over network 100.

In step S32, the proposed embryology and politics policies are evaluated and/or refined. The output of this step consists of reformulated and/or validated target policies for organizational adoption. Computer system 10 may be used in this step to process relevant data. The data and the results of the processing may be communicated over network 100.

In step S33, the proposed diversity and connectivity policies are practiced with the evaluated and/or refined politics and embryology policies. In other words, step S33 subjects the remaining prescribed policies to the customized political and embryology systems. That is, in step S33, the two remaining policy areas of interest in defining an organization's target KOS are specified for organizational adoption. These are the Diversity and the Connectivity aspects of a knowledge operating system. The conclusions reached at step S32 are specifically revisited here, too. Computer system 10 may be used in step S33 for processing data contained in data stores 30 during the practice. The data and the results of the processing may be communicated over network 100.

In step S34, the proposed politics, embryology, diversity and connectivity policies are evaluated and/or refined. The output of this step consists of reformulated and/or validated target policies for organizational adoption. Computer system 10 may be used in this step to process relevant data. The data and the results of the processing may be communicated over network 100.

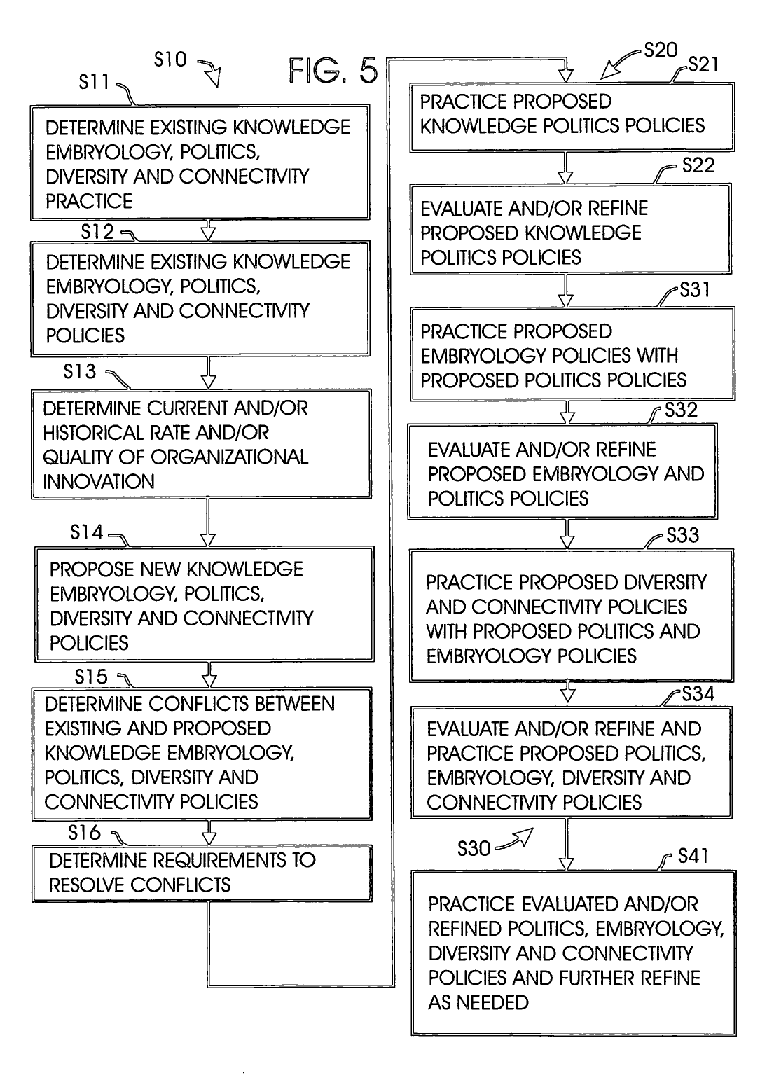

Referring to FIG. 5, in step S41, this step consists of implementing the policy transformation initiatives planned and initially deployed in previous steps. The evaluated and/or refined politics, embryology, diversity and connectivity polices as determined in steps S32 and S34, in particular, are practiced on a continuing basis and are periodically reevaluated and further refined, as needed. All such refinements are made in response to ongoing measurements of change, if any, detected in the rate and/or quality of innovation as determined by the use of the same, or similar, tools and techniques used in step S13. This is a open-ended step which continues indefinitely into the future. Computer system 10 may be used in this step to process relevant data contained in data stores 30. The data and the results of the processing may be communicated over network 100.

There are several steps in which the proposed policies are synchronized with the tendency of the human social system to self organize around one or more of the production, diffusion and application of organizational knowledge. These steps include S14, S15, S16, S21, S22, S31, S32, S33, S34 and S41.

Another embodiment of the invention includes providing instruction concerning all of steps S11-S41. The steps are the same as previously described, except that instruction is provided instead of actually implementing the steps in a human social system as described in connection with steps S11-S41. Such instruction includes teaching and consulting.

While particular elements, embodiments and applications of the present invention have been shown and described, it will be understood that the invention is not limited thereto since modifications may be made by those skilled in the art, particularly in light of the foregoing teachings. It is therefore contemplated by the appended claims to cover such modifications as incorporate those features which come within the spirit and scope of the invention.

1. In a human social system where members of the social system have a predisposition toward behaviors that result in innovation, a method of managing the members of the social system to increase the rate of innovation by the members by implementing a knowledge policy that is consistent with, and reinforces, the predisposition toward behaviors that result in innovation, comprising:
determining a preexisting knowledge policy for the social system;
proposing a new knowledge policy for the social system based on the behaviors of the members that result in innovation under the pre-existing knowledge policy;
practicing the new knowledge policy within the social system;
evaluating the effect of practicing the new knowledge policy on the behaviors that result in innovation within the social system as compared with the effect of the preexisting knowledge policy on the behaviors that result in innovation within the social system;
refining, if necessary, the new knowledge policy to increase reinforcement of the behaviors that result in innovation in order to increase the rate of innovation within the social system in response to the evaluating step; and
practicing any refined new knowledge policy within the social system.

2. In a human social system having a tendency to self organize around one or more of the production, diffusion and application of organizational knowledge, a method of managing one or more of the production, diffusion and application of such knowledge comprising synchronizing at least one knowledge policy with said tendency, said synchronizing comprising:
determining a preexisting knowledge politics policy for the social system,
proposing a synchronized knowledge politics policy for the social system,
practicing the proposed synchronized knowledge politics policy for the social system,
evaluating the practice of the proposed synchronized knowledge politics policy for the social system compared with the preexisting knowledge politics policy for the social system,
refining if necessary the proposed synchronized knowledge politics policy for the social system in response to the evaluating; and
practicing any refined synchronized knowledge politics policy in the social system.

3. A method as claimed in claim 2 wherein said synchronizing further comprises:
determining at least one of a preexisting knowledge embryology policy for the social system and the preexisting knowledge politics policy for the social system;
proposing at least one of a knowledge embryology policy for the social system and the knowledge politics policy for the social system;
practicing at least one of the proposed knowledge embryology policy for the social system and the proposed knowledge politics policy for the social system;
evaluating the practice of said at least one of the proposed knowledge embryology policy for the social system and the proposed knowledge politics policy for the social system compared with the at least one of the preexisting knowledge embryology policy for the social system and the preexisting knowledge politics policy for the social system;
refining if necessary the at least one of the proposed knowledge embryology policy for the social system and the proposed knowledge politics policy for the social system in response to the evaluating; and
practicing any refined policy from the group consisting of the proposed knowledge embryology policy for the social system and the proposed knowledge politics policy for the social system.

4. A method as claimed in claim 2 wherein said synchronizing further comprises:
determining at least one of a preexisting knowledge embryology policy, the preexisting knowledge politics policy, a preexisting knowledge diversity policy and a preexisting knowledge connectivity policy in the social system;
proposing at least one of a knowledge embryology policy, the proposed knowledge politics policy, a knowledge diversity policy and a knowledge connectivity policy in the social system;
practicing at least one of the proposed knowledge embryology policy, knowledge politics policy, knowledge diversity policy and knowledge connectivity policy in the social system;
evaluating the practice of said at least one of the proposed knowledge policies in the social system compared with the at least one of the preexisting knowledge policies in the social system;
refining if necessary the at least one of the proposed knowledge policies in the social system in response to the evaluating; and
practicing any refined policy from the group consisting of the proposed knowledge embryology policy, the proposed knowledge politics policy, the proposed knowledge diversity policy and the proposed knowledge connectivity policy.

5. A method, as claimed in claim 3, and further comprising:
determining conflicts between at least one of the preexisting knowledge embryology policy and the preexisting knowledge politics policy and at least one of the proposed knowledge embryology policy and the proposed knowledge politics policy; and
determining requirements to resolve said conflicts.

6. A method, as claimed in claim 4 and further comprising:
determining conflicts between at least one of the preexisting knowledge diversity policy and the preexisting knowledge connectivity policy and at least one of the proposed knowledge diversity policy and the proposed knowledge connectivity policy; and
determining requirements to resolve said conflicts.

7. A method, as claimed in claim 4 and further comprising determining at least one characteristic of the social system.

8. A method, as claimed in claim 7, wherein the one characteristic comprises innovation rate.

9. A method, as claimed in claim 7, wherein the one characteristic comprises innovation quality.

10. A method, as claimed in claim 7, and further comprising refining at least one of said proposed knowledge embryology policy, said proposed knowledge politics policy, said proposed knowledge diversity policy and said proposed knowledge connectivity policy in response to said at least one characteristic.

11. A method, as claimed in claim 2 and further comprising:
practicing a proposed knowledge embryology policy with the evaluated proposed knowledge politics policy;
evaluating the proposed knowledge embryology policy and evaluated proposed knowledge politics policy as practiced together in the social system; and
practicing the evaluated proposed knowledge embryology policy, twice evaluated proposed knowledge politics policy, a proposed knowledge diversity policy and a proposed knowledge connectivity policy together in the social system.

12. A method, as claimed in claim 11, and further comprising refining if necessary the proposed knowledge embryology policy, the proposed knowledge politics policy, the proposed knowledge diversity policy and the proposed knowledge connectivity policy in response to said practicing the evaluated proposed knowledge embryology policy, twice evaluated proposed knowledge politics policy, proposed knowledge diversity policy and proposed knowledge connectivity policy together in the social system.

13. A method, as claimed in claim 2, wherein said social system comprises an organization.

14. A method, as claimed in claim 13, wherein said organization comprises a business.

15. In a human social system having a tendency to self organize around one or more of the production, diffusion and application of organizational knowledge, said system including a data store and a communication network, a method of supporting the management of one or more of the production, diffusion and application of said organizational knowledge and the synchronizing of at least one knowledge policy with said tendency, said method comprising:
storing data relating to one or more of said organizational knowledge and the at least one knowledge policy in the data store; and
communicating over the network to facilitate said synchronizing, the synchronizing comprising
using the data store and the network to determine a preexisting knowledge politics policy for the social system,
communicating over the network data needed to propose a synchronized knowledge politics policy for the social system;
using the data store and the network to facilitate practicing the proposed synchronized knowledge politics policy for the social system,
using the data store and the network for evaluating the practice of the proposed synchronized knowledge politics policy for the social system compared with the preexisting knowledge politics policy for the social system,
using the data store and the network for refining if necessary the proposed synchronized knowledge politics policy for the social system in response to the evaluating, and
using the data store and the network to facilitate practicing any revised synchronized knowledge politics policy.
